(19) United States
(12) Patent Application Publication
(10) Pub. No.: US 2024/0184578 A1
(43) Pub. Date: Jun. 6, 2024

(54) NEOHARRY: HIGH-PERFORMANCE PARALLEL MULTI-LITERAL MATCHING ALGORITHM

(71) Applicant: Intel Corporation, Santa Clara, CA (US)

(72) Inventors: Hao CHANG, Shanghai (CN); Geoffrey LANGDALE, Camperdown (AU); Xiang WANG, Shanghai (CN); Yang HONG, Shanghai (CN); Wenjun ZHU, Shanghai (CN); Kun QIU, Shanghai (CN); Xusheng LU, Mesa, AZ (US)

(21) Appl. No.: 18/440,818

(22) Filed: Feb. 13, 2024

(30) Foreign Application Priority Data
Dec. 27, 2023 (WO) PCT/CN2023/142442

(51) Int. Cl. G06F 9/30; G06F 9/38; G06F 15/80

(52) U.S. Cl. CPC G06F 9/30038; G06F 9/30032; G06F 9/30043; G06F 9/3887; G06F 15/8084

(57) ABSTRACT

Methods and embodiments of a high-performance parallel multi-literal matching algorithm called NeoHarry. A chunk of data comprising a character string comprising n bytes is sampled for a byte stream, and data in the sampled chunk are pre-shifted to create shifted copies of data at multiple sampled locations. A mask table is generated having column vectors containing match indicia identifying potential character matches. A look up of the mask table at multiple sampled locations using the pre-shifted data is performed for a target literal character pattern. The mask table lookup results are combined to generate match candidates and exact match verification is performed to identify any generated match candidates that match the target literal character pattern. NeoHarry uses a column-vector-based shift-or model and implements a cross-domain shift algorithm under which character patterns spanning two domains are identified.

### CLAIM OF PRIORITY

The present application claims the benefit of priority to Patent Cooperation Treaty (PCT) Application No. PCT/CN2023/142442 filed Dec. 27, 2023, the entire contents of which is incorporated herein by reference.

### BACKGROUND INFORMATION

Literal matching is widely used in scenarios such as network I/O, network intelligence, DPI (Deep Packet Inspection), WAF (Web Application Firewall), search engine, NLP (Natural Language Processing), etc. The world's fastest literal matching algorithm on Intel® platform is provided by Hyperscan. Hyperscan can seamlessly support processors from Atom® to Xeon®, it is highly optimized for Intel® platform and has been integrated in large amount of open-source solutions and use cases, like IDS/IPS solutions Snort and Suricata, DPI solution ntop, WAF solution ModSecurity, Spam Filtering System Rspamd, Database Clickhouse, Github and so on.

Hyperscan is a high-performance regex matching library, and its use of multi-literal matching algorithms is described in detail in a whitepaper authored by Wang, Xiang, et al. “Hyperscan: a fast multi-pattern regex matcher for modern CPUs.” 16th {USENIX} Symposium on Networked Systems Design and Implementation (NSDI '19), February 2019. An initial multi-literal matching algorithm described in the Hyperscan whitepaper is named “FDR.” The FDR algorithm is a SIMD (Single Instruction Multiple Data) accelerated multiple-string matching algorithm.

Recently, an improved multi-literal matching algorithm based on FDR called “Harry” has been introduced and is currently used by Hyperscan. Harry is described in detail H. Xu, H. Chang, W. Zhu, Y. Hong, G. Langdale, K. Qiu, and J. Zhao, “Harry: A scalable SIMD-based multi-literal pattern matching engine for deep packet inspection,” in IFFE INFOCOM 2023—IEEE Conference on Computer Communications, 2023, pp. 1-10. Harry is an AVX512 (advanced vector extension 512-bit) based multi-literal matching algorithm designed to achieve high-performance in large-scale cases.

### BRIEF DESCRIPTION OF THE DRAWINGS

The foregoing aspects and many of the attendant advantages of this disclosure will become more readily appreciated as the same becomes better understood by reference to the following detailed description, when taken in conjunction with the accompanying drawings, wherein like reference numerals refer to like parts throughout the various views unless otherwise specified:

FIG. 1 is a SHIFT-OR mask table illustrating positions of character entries used for 8-byte literal matching;

FIG. 2 shows an example of Harry's table look-up and SHIFT-OR process;

FIG. 3 is a diagram illustrating examples of false positive and pattern matches using Harry;

FIG. 4 is a diagram illustrating the architecture implemented for NeoHarry, according to one embodiment;

FIG. 5 is a diagram illustrating aspects of NeoHarry's column-vector-based shift-or model, according to one embodiment;

FIG. 6a is a diagram illustrating operation the VPERMB instruction;

FIG. 6b is a diagram illustrating the NeoHarry Load operation;

FIG. 7 is a diagram illustrating aspects of truncation-based encoding;

FIG. 8 is a diagram illustrating a mask table change from an initial table of 4096×8 cells to a compressed table of 64×16 cells using an example of decomposition encoding, according to one embodiment;

FIG. 9 is a diagram illustrating the DNeoHarry Load operation, according to one embodiment;

FIG. 10 is a diagram illustrating an example of an Encoding False Positive;

FIG. 11 is a diagram illustrating how elements from a last domain and current domain are combined to support cross-domain matching;

FIG. 12 is a diagram graphically illustrating an example of the cross-domain shift algorithm, according to one embodiment;

FIG. 13 is a flowchart illustrating workflow operations implemented by NeoHarry, according to one embodiment;

FIG. 14 is a diagram illustrating an example workflow using the NeoHarry algorithm;

FIG. 15 is a diagram comparing instruction dependency graphs for Harry and NeoHarry;

FIG. 16 is a diagram illustrating an instruction pipeline of Shift- Or matching for Harry and NeoHarry for CPU ports 0, 1, 2, and 5 for an Intel® Xeon® Platinum 8380 CPU; and

FIG. 17 is a diagram of a computing system that may be implemented with aspects of the embodiments described and illustrated herein.

### DETAILED DESCRIPTION

Embodiments of methods and apparatus for high-performance parallel multi-literal matching algorithm are described herein. In the following description, numerous specific details are set forth to provide a thorough understanding of embodiments of this disclosure. One skilled in the relevant art will recognize, however, that aspects of the embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments described and illustrated herein, a new algorithm called “NeoHarry” is disclosed. NeoHarry uses a new column-vector-based SHIFT-OR model and a cross-domain shift algorithm to improve both data and instruction processing parallelism. It can process 64 characters (1.14× of Harry) in parallel. NeoHarry also shifts the load on Central Processing Unit (CPU) port 5 to other ports, which makes better balancing among CPU ports and better instruction parallelism.

### Hyperscan's Large Scale Multi-Literal Matcher “Harry”

Hyperscan's large scale multi-literal matcher “Harry” is a SHIFT-OR algorithm that applies SIMD instructions to find match candidates in input data. To prepare the masks that used by SHIFT-OR algorithm, it performs table look-up operations for each 56 bytes input data and performs SHIFT-OR for every 56 bytes chunk at a time, which is not fully utilizing AVX512's ability to process 64 bytes or 512 bits, because the left-SHIFT operation inside 512-bit vector will lose valid information at the lowest bytes. Also, Harry leverages the AVX512 VPERMB (Permute Packed Bytes Elements) instruction to perform both table look-up and SHIFT operations, which creates a bottleneck on CPU execution port 5. Both weaknesses limit Harry's overall performance.

In one implementation Harry leverages AVX512 instructions to quickly find match candidates in a bunch of input data. Harry uses a character mask table for literal matching, wherein the table is constructed according to the literal patterns. For both performance and accuracy concern, Harry constructs the table according to 8-byte suffixes of patterns.

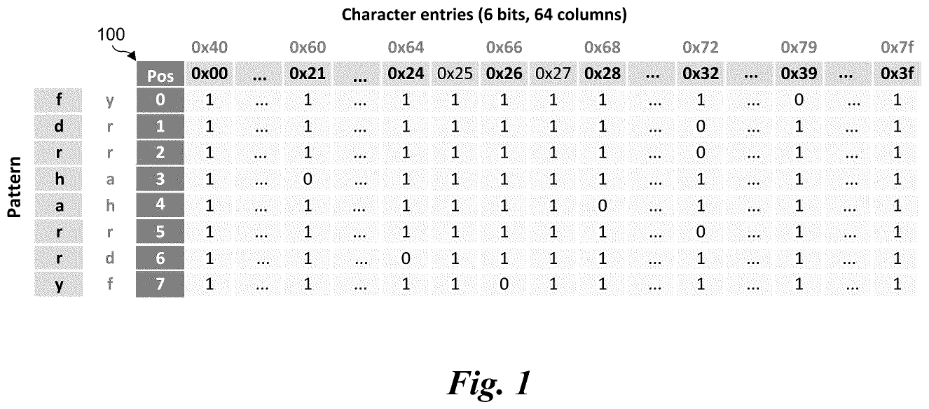

For example, if we consider an 8-byte literal pattern ‘f d r h a r r y’, its corresponding simplified SHIFT-OR mask table 100 is illustrated in FIG. 1. A complete version of SHIFT-OR mask table 100 has 8 rows and 64 columns. The simplified table illustrated in FIG. 1 covers all English ASCII characters with region 0x40˜0x7f, the low 6-bit value is in the region of 0x00˜0x3f, indicating the matching result of each character at each position of the pattern. A cell with value 0 means the corresponding character matches the corresponding position of the pattern. For multiple literal patterns, we group them into different buckets according to their lengths and similarities. Harry can support up to 8 buckets by using 8 bits in each cell.

In FIG. 1 the simplified, SHIFT-OR mask table 100 includes 8 rows for literal pattern ‘f d r h a r r y’ and 64 columns that represent characters in the region of 0x40 to 0x7f of the extended ASCII table using the simplified hexadecimal values based on these character's low 6-bit values. A cell of simplified, SHIFT-OR mask table 100 with a value of ‘0’ represents a match indicia that indicates that a corresponding character matches a corresponding position of the 8-byte literal pattern of ‘f d r h a r r y’.

In some examples, the Harry algorithm leverages a SIMD instruction executed by a processor such as, but not limited to, an AVX-512 VPERMB instruction to perform a parallel table lookup for 64 bytes of input data (e.g., 64-byte character string) based on simplified, SHIFT-OR mask table 100. The processor may include one or more cores and may be an Intel® processor, an AMD® processor, an ARM®-based processor, or a RISC-V processor. Some Intel® processors such as, but not limited to, Xeon® processors or some AMD® processors such as, but not limited to Zen® processors may be capable of executing the AVX-512 VPERMB instruction. AMD® Zen 4 processor also has a VPERMB instruction. Other processors such as, but not limited to, an ARM®-based processor, or a RISC-V processor, with SIMD or vector extensions may be capable of executing instructions that are closely equivalent to the VPERMB instruction. For example, ARM® NEON® SIMD extension has TBL/TBX instructions, which are functionally similar to VPERMB (in that they allow selection of a byte from 1, 2, 3 or 4 registers). The subsequent ARM® vector extension, SVE/SVE2, also provides TBL/TBX instructions, which offer similar functionality.

For these examples, execution of the VPERMB instruction (or instruction with similar functionality) may cause or facilitate a parallel table lookup of all 8 rows of simplified, SHIFT-OR mask table 100 for the 64 bytes of input data. Thus, enabling table lookup for a match candidate in the entire 64 bytes of input data at a time compared to the FDR algorithm's ability to perform table lookup of just 8 bytes of input data at a time.

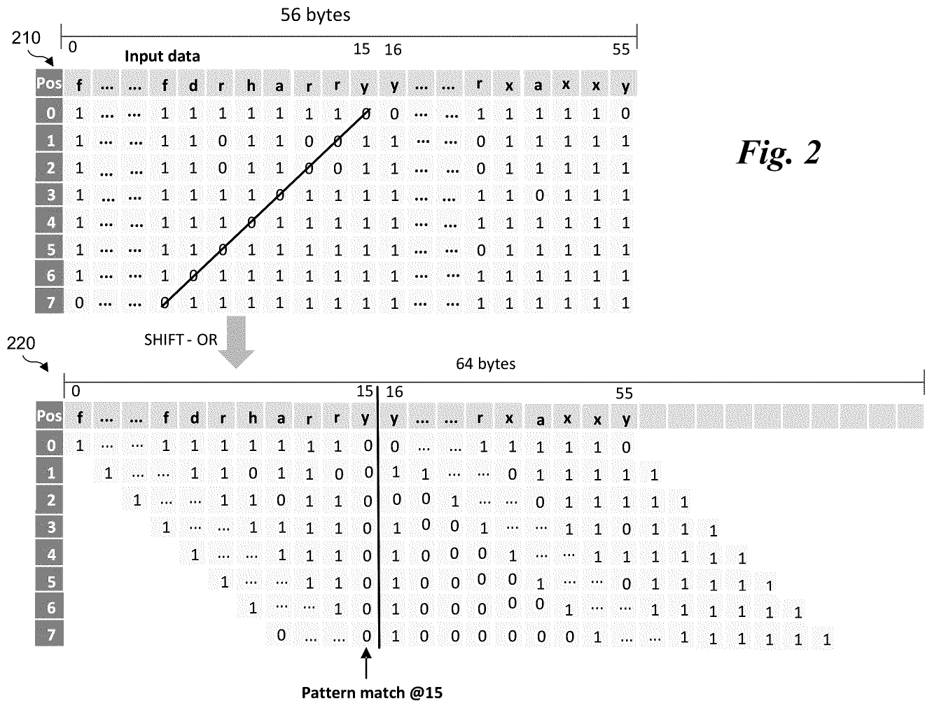

Harry performs pattern matches for 56-byte chunks of input data at a time. It takes the input data as control mask, takes each row of the table shown in FIG. 1 as source mask and leverages the VPERMB instructions to do parallel table look-up 8 times. Then it also leverages VPERMB to do left-SHIFT for each table look-up result (which can shift across 128-bit lane boundaries). Finally, Harry OR's them together to get the matching result. FIG. 2 shows an example of Harry's table look-up and SHIFT-OR process, where the column with all 0s indicates a match candidate at offset 15 of input data. In FIG. 2, the upper table 210 shows the search string with of the 8-byte literal pattern of ‘f d r h a r r y’ pattern, and 8 rows of input data prior to shifting, while the lower table 220 shows the same input data after shifting.

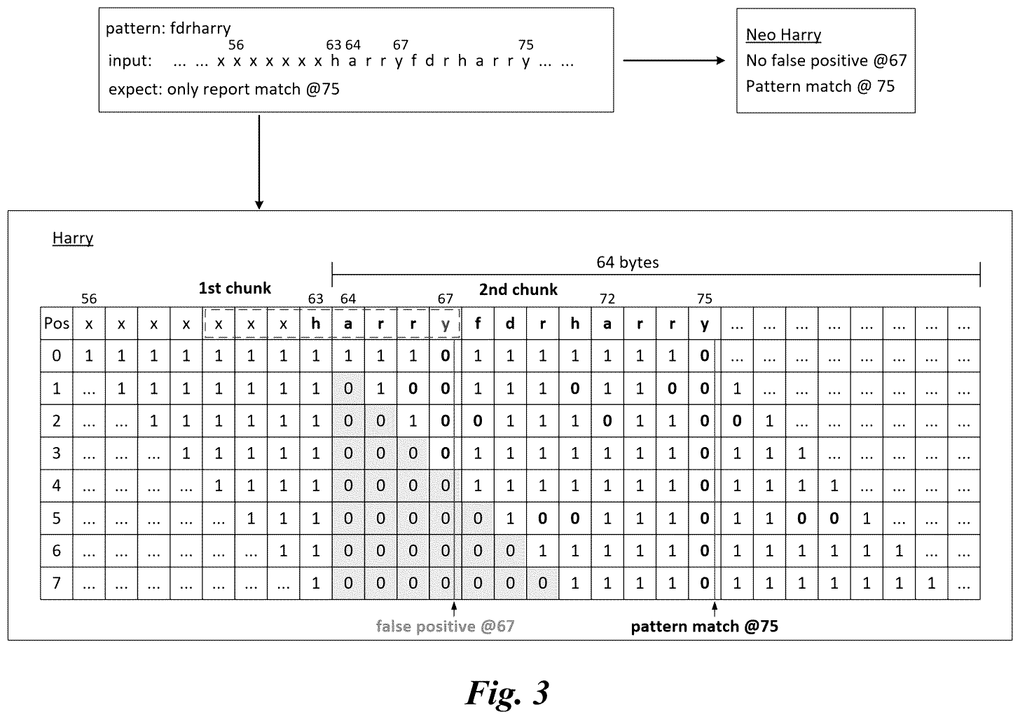

Harry processes only 56 bytes at a time using a sequence of 512-bit vector instructions, but ideally a 512-bit vector should handle up to 64 bytes at a time. The reason why Harry cannot process 64 bytes per iteration is illustrated in FIG. 3. Here, we assume the 2nd 64-byte chunk of input data starts with ‘arry’ (offset 64 . . . 67), which doesn't match at offset 67. But when leveraging VPERMB to do left-SHIFT in the 2nd chunk, the table look-up results from the 1st chunk cannot pass the 512-bit vector boundary, the padding zeros at the beginning of the 2nd chunk will generate a false positive at offset 67 in this case. To get rid of this type of false positives, Harry loads overlap by 8 bytes between contiguous chunks, so Harry only processes 56 bytes per chunk.

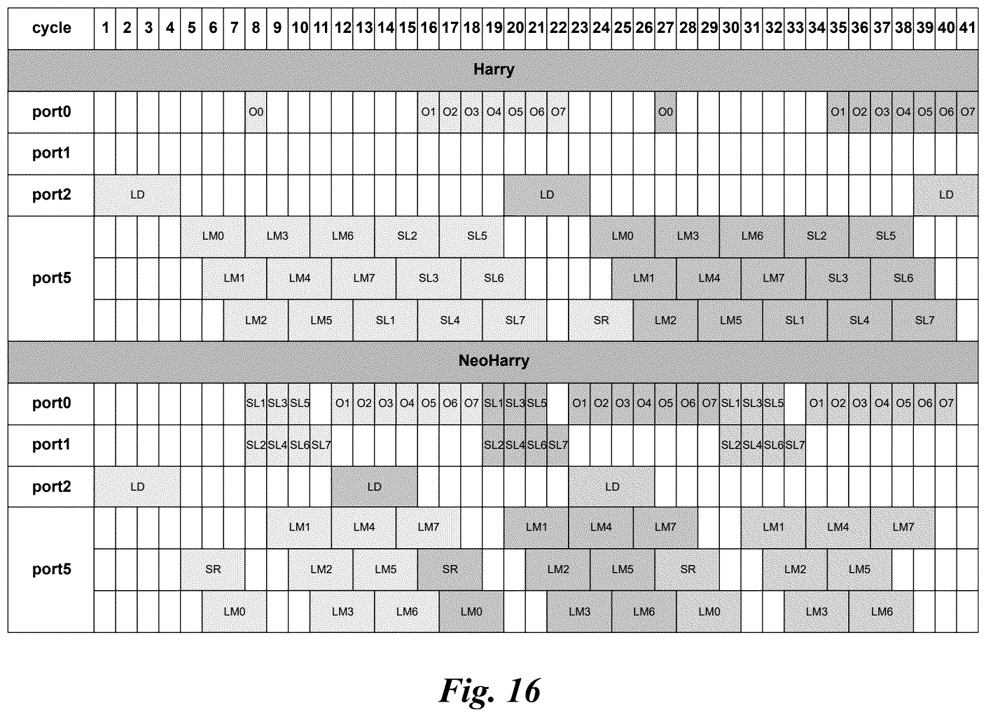

Harry also results in unbalanced loads on CPU ports. Harry leverages the VPERMB instruction to perform not only table look-up operations, but also SHIFT operations. All these operations are running on CPU port 5, which causes poor instruction parallelism, since Intel® processors such as the Xeon® Platinum 8380 CPU have alternative ports capable of running AVX-512 instructions. This problem is illustrated below with reference to FIG. 16.

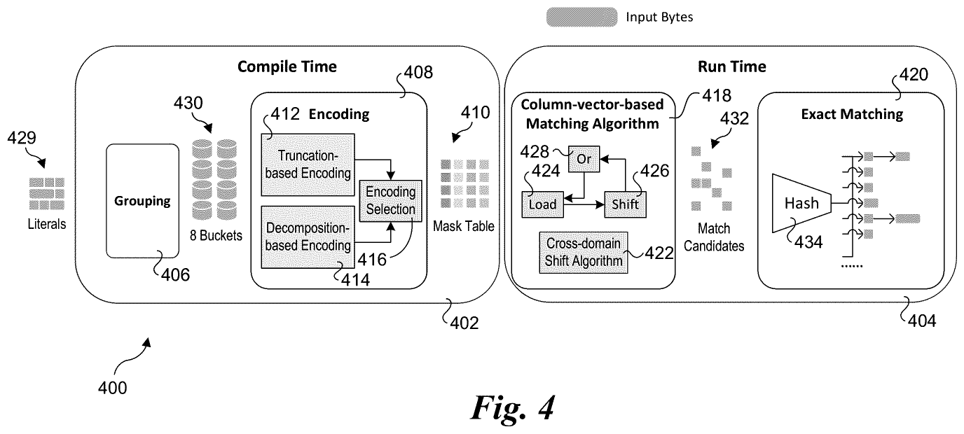

FIG. 4 shows a diagram illustrating an architecture 400 of NeoHarry, according to one embodiment. At the top level, architecture 400 includes a compile time block 402 and a run-time block 404. Compile time block 402 includes a grouping operation 406, an encoding block 408, and a mask table 410. Encoding block 408 performs encoding operations including truncation-based encoding 412 and decomposition-based encoding 414 whose outputs are fed into an encoding selection block 416 that selects which type of encoding to use.

Run-time block 404 includes a column-vector-based matching algorithm 418 and an exact matching block 420. Column-vector-based matching algorithm 418 includes a cross-domain shift algorithm 422, a load operation 424, a shift operation 426, and an Or operation 428.

The workflow performed by NeoHarry is illustrated from left-to-right. Literals 429 are input to compile time block 402 and are grouped by grouping operation 406 into 8 buckets 430. Data in the 8 buckets are encoded by encoding block 408 to generate mask table 410. During run-time, column-vector-based matching algorithm 418 outputs match candidates 432. These match candidates are then processed using a hash function 434 (or similar function) in exact matching block 420, which identifies literals with exact matches.

Under Harry, SHIFT operations are performed on rows (whose data comprise row vectors), as discussed and illustrated above. Conversely, under NeoHarry, SHIFT operations are performed on column vectors (data in columns), using a column-based shift-or model, described and illustrated in further detail below. This reduces the number of SIMD operations per input byte and increases the level of parallelism.

Although the column-vector-based shift-or model is more efficient, implementing it on modern CPU is not that easy, since it needs a 2048-bit-long SIMD register to hold the column vector of the mask table, while the longest SIMD register of a modern CPU has only 512 bits (CPU with AVX512 instruction set). To address this hardware limitation, new encoding methods have been designed to compress the mask table, so that we can use 512-bit-long SIMD registers to implement the matching algorithm.

To identify the cross-domain match results, NeoHarry concatenates two masks that are mp bits long and shifts the temporary 2mp-bit-long mask to get a residual result. There is no SIMD instruction that is available to directly implement this process, so a novel cross-domain shift algorithm has been developed based on existing SIMD instructions.

### Column-Vector-Based SHIFT-OR Model

The core of the column-vector-based shift-or model is its shift-or process as shown in FIG. 5. To illustrate the shift-or process of NeoHarry, we suppose there are 8 input bytes in each domain. The mask table is arranged by columns and contains 8 2048-bit-long column vectors. The shift-or process is shown as operations 1→2→3 (respectively depicted by encircled numbers ‘1’, ‘2’, and ‘3’ in FIG. 5). In the first operation ‘1’, input bytes are taken as indices to LOAD elements from the 8 columns of the mask table and form the match table. In operation ‘2’, the match table of the current domain is combined with the match table of the last domain by column and the combined column vectors are SHIFTed 7 times. The area in the solid-line rectangle 502 reflects the cross-domain match results and the area in the dashed rectangle 504 reflects match results in current domain. In operation ‘3’, OR operations are performed on the shifted column vectors and get the state mask, where BIT 0 indicates a positive match and BIT 1 indicates no match. The column-vector-based shift-or model of NeoHarry performs LOAD, SHIFT, and OR operations on column vectors.

This model provides several advantages: First, the number of SIMD instructions (LOAD, SHIFT, and OR) does not rely on m, the number of input bytes processed in an iteration, but is fixed. This implies that no matter how many input bytes are processed in an iteration, NeoHarry always needs 22 SIMD instructions (8 LOAD, 7 SHIFT and 7 OR).

Second, the SIMD register can be filled with data bits, with no need to leave some space for shifting, which increases m. NeoHarry does not need to care about the lost bits during shifting as it combines the adjacent match tables to SHIFT and the lost bits will be seen in the next iteration. So, for NeoHarry there is:

8m=L

In AVX512 where L=512, Harry takes m=64, which demonstrates that it needs only 22 SIMD instructions per 64 input bytes.

### Encoding Methods

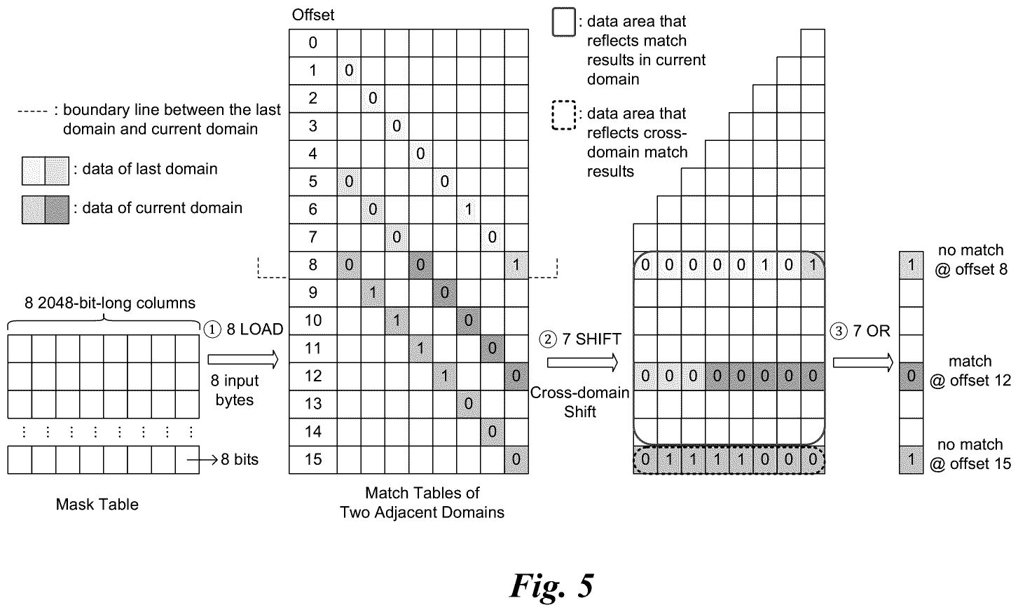

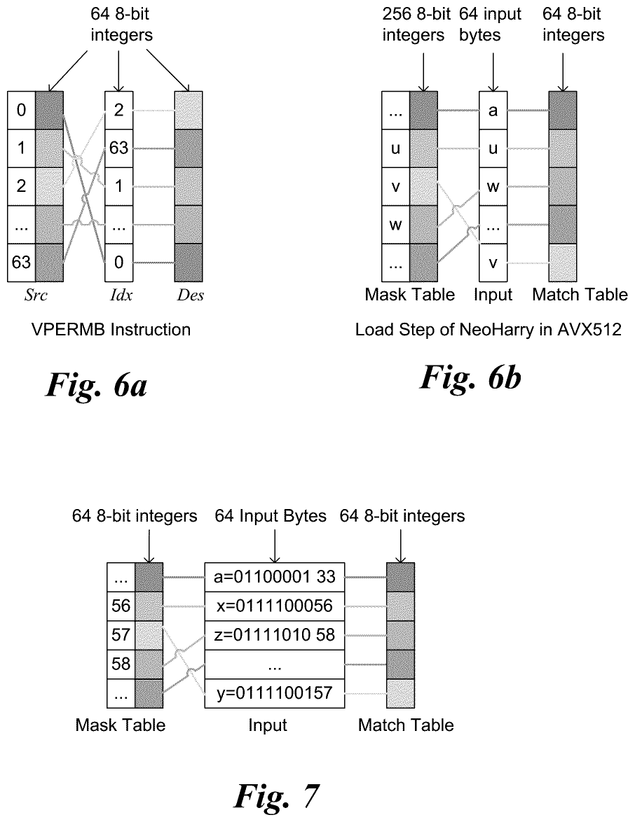

As discussed above, NeoHarry needs to load elements from 2048-bit-long column vectors. This operation is accomplished by VPERMB, the SHUFFLE instruction of AVX512. The VPERMB instruction is shown in FIG. 6a and the load operation of NeoHarry is show in FIG. 6b. As shown in FIG. 6a, VPERMB shuffles 8-bit integers in Src across lanes using the corresponding indices in Idx, and stores the result in Des. As shown in FIG. 6b, taking 64 input characters as indices, NeoHarry picks 64 8-bit integers from a mask table column that includes 256 8-bit integers.

VPERMB is the target SIMD instruction that is suitable for implementing NeoHarry's load operation. However, there is a problem that the source vector of VPERMB, which has 64 8-bit integers, cannot hold the column vector of mask table, which has 256 8-bit integers. This is the main difficulty in implementing the column-vector-based algorithm. As a result, methods for compressing the mask table are needed.

One method of encoding employs compression-based encoding. Usually, the input string contains only the commonly used ASCII characters, which are 0x00˜0x7f. Therefore, we can compress the mask table to be 128 rows. Even more, if only consider the English characters which are 0x40˜0x7f, we can further compress the mask table to be of 64 rows, so a column vector has only 64×8=512 bits, which is right inside an AVX512 SIMD register. Besides, because the low 6 bits of English characters (0x40˜0x7f) are 000000˜111111, we can load elements from the mask table by the low 6 bits of the input characters, as shown in FIG. 7. Here, we compress the mask table by truncating a byte and considering only its lower 6 bits, so we call this encoding method “truncation-based encoding” and we call NeoHarry with this encoding method “TNeoHarry”. As shown in FIG. 7, after compressing the mask table has only 64 rows and its column vector has 64 8-bit integers. For the 64 input characters ‘axz . . . y’, take their low 6 bits as indices to pick elements from the column vector of the mask table.

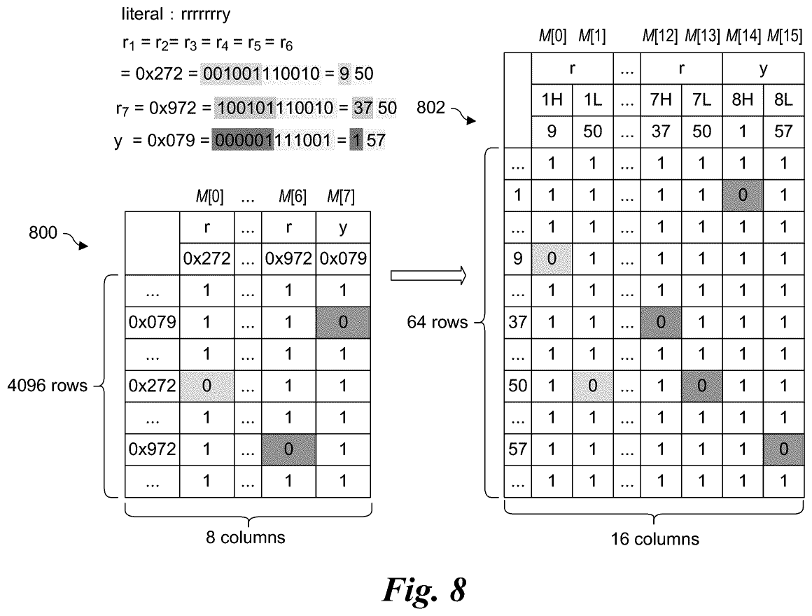

A second method of encoding employs decomposition-based encoding. Under FDR, false positives caused by grouping were reduced using a super character set to encode the FDR mask table. This approach uses 9-15 bits to represent a single character, with the lower 8 bits being the character's 8 ASCII bits and the higher 1-7 bits being the next character's low-level first through seventh bits. Using an example 12-bit encoding, we can see that, for ‘a’=01100001 and ‘d’=01100100, if the input string is ‘ad’, then the encoding of ‘a’ would be 010001100001. Rather than compressing the mask table, FDR enlarges its mask table from 256 masks to 4096 masks. This can significantly reduce the false positives as it introduces more information to the mask table. If NeoHarry takes FDR's encoding, the column vector of mask table would contain 4096×8 bits, which is far beyond what a SIMD register can hold. An alternative scheme is implemented to compress the mask table by decomposing the 12 bits into high 6 bits and low 6 bits. The mask table is changed as shown in FIG. 8.

Suppose the literal is ‘r r r r r r y’. The left table 800 is the mask table before decomposing. In the original ASCII character set, ‘r’ is 0x72 and ‘y’ is 0x79. According to FDR's super character set, ‘r1′˜′r6’ are encoded as 0x272, ‘r7’ is encoded as 0x972, ‘y’ is encoded as 0x079. After decomposing, each 12-bit character is regarded as two 6-bit parts, one high part (H) and one low part (L). We use a decimal value to represent a 6-bit part and it should be between 0 and 63. The dimension of mask table 804 has changed from 4096×8 to 64×16.

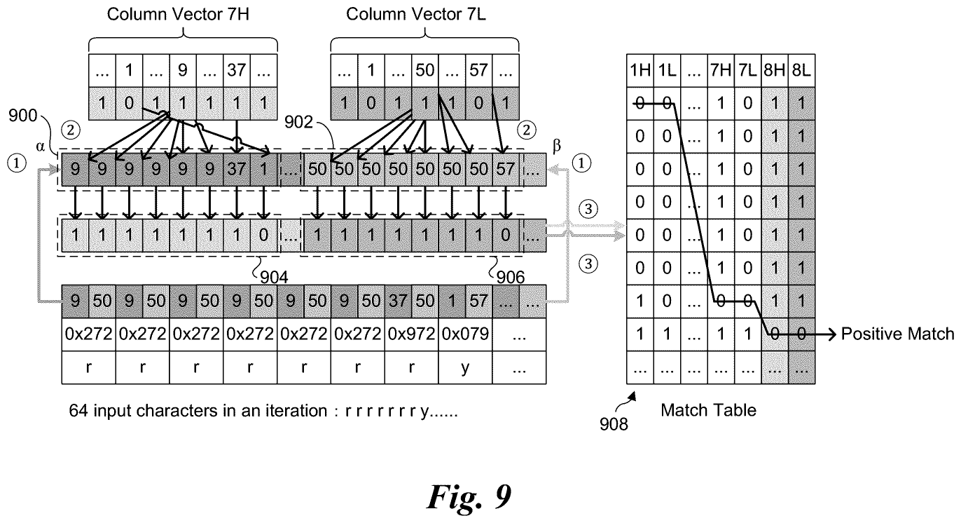

After decomposition, the column vector just contains 64×8=512 bits. We call NeoHarry with this decomposition-based encoding as “DNeoHarry”. For DNeoHarry, the operation to load elements from column vectors of the mask table is also changed, as shown in FIG. 9. As before, the operations are depicted by encircled numbers ‘1’, ‘2’, and ‘3’. For input characters {‘r’, ‘r’, ‘r’, ‘r’, ‘r’, ‘r’, ‘r’, ‘y’}, decompose them into two vectors, as depicted by operation ‘1’. The first vector 900 contains the high 6-bit decimal values of the input characters and the second vector 902 contains the low 6-bit decimal values. We mark them as a and B. We then use VPERMB in operation ‘2’ to pick elements from Column Vector 7H and Column Vector 7L (the last two column vectors of the new mask table 802 in FIG. 8), taking a and B as index vectors, respectively. Finally, during the third operation ‘3’ the picked elements 904 and 906 are put in match table 908.

It can be seen from FIGS. 8 and 9 that the number of LOAD operations, after decomposing the 12 bits, has doubled because the number of mask table columns doubled. Additionally, before shifting, 8 additional OR operations should be performed on the 8 pairs of H and L vectors in the match table. For DNeoHarry, it needs 16 additional SIMD operations (8 LOAD and 8 OR), so in total it needs 38 SIMD operations per 64 input characters, which equates to 0.59 SIMD operation per character.

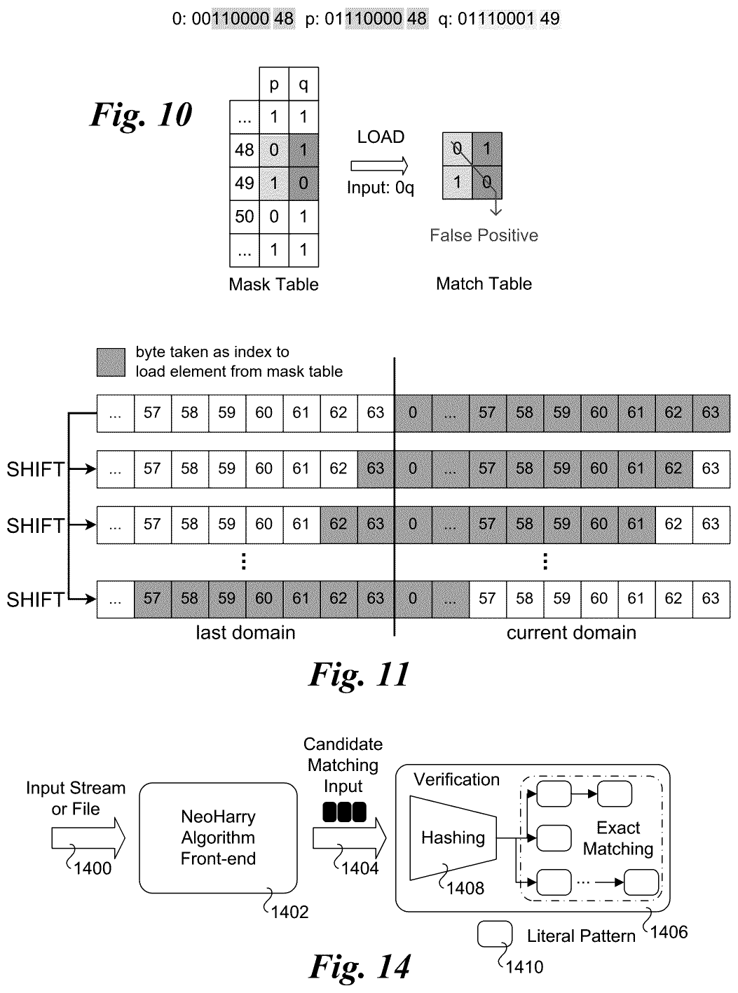

As discussed above, grouping and truncation may introduce false positives. We call them GPF (Grouping False Positive) and TFP (Truncation False Positive). Here the new encoding methods also introduce false positives as some information will be lost after compressing the mask table. Take truncation-based encoding as an example, which may produce false positives such as shown in FIG. 10. Suppose the literal is ‘pq’ and the input string is ‘0q’. Since ‘0’ has the same lower 6 bits as ‘p’, ‘0q’ wrongly matches ‘pq’, which is a false positive result.

These false positives are called EFP (Encoding False Positive), which are produced because some information is lost after compressing the mask table. The decomposition-based encoding introduces fewer EFPs than the compression-based encoding because the mask table of DNeoHarry is twice the size of TNeoHarry and contains more valid information. False positives are filtered out in the exact matching stage, so the two encoding methods that introduce EFPs will increase the exact matching time. However, the overall performance of NeoHarry still provides improvement related to Harry because the efficient column-vector-based shift-or model can be implemented on modern CPUs due to the encoding methods and this largely decreases the shift-or matching time.

Both encoding methods have their advantages and disadvantages. The compression-based encoding needs no more SIMD operations, but it introduces more EFPs. The decomposition-based encoding introduces much fewer EFPs but needs more SIMD

operations. In FIG. 10, if the bucket contains only ‘rq’, then bit T[48][0] will change from 0 to 1 and the false positive will not appear. Generally, the more zero bits there are in mask table, the more false positives there will appear during matching. In practice, NeoHarry decides on which method to take by comparing the zero-bit rates of TNeoHarry and DNeoHarry, which we mark as tzr and dzr. In one embodiment a heuristic selection algorithm is executed. When tzr is relatively low, which means that the compression-based encoding would not introduce too many false positives, NeoHarry will select the compression-based encoding (TNeoHarry) because it needs less SIMD operations. When tzr is relatively high, which means that the compression-based encoding would produce much more false positives than the decomposition-based encoding, NeoHarry will select the decomposition-based encoding (DNeoHarry).

### Cross-Domain Shift Algorithm

Since the input byte stream can be of arbitrary length, NeoHarry employs multiple iterations of processing. With the AVX512 SIMD instruction set, NeoHarry can handle 64 bytes in each iteration. The portion of bytes processed in each iteration is termed a domain. If a match occurs within a domain, it is an intra-domain match. If a match spans two domains (during the shift-or matching phase only the 8-byte suffix of the literal is matched, so a match can at most span two domains and it cannot span three or more domains), it is a cross-domain match.

NeoHarry combines input bytes of a last iteration and a current iteration to load elements from the mask table, to guarantee the cross-domain matches are not missed. This process is illustrated in FIG. 11, where each domain has 64 bytes that are in a 512-bit long SIMB register. The shaded bytes are those used as indices to load elements from the mask table.

The cross-domain shift is to concatenate two 64-byte registers to get a temporary 128-byte-long tmp, shift tmp left i bytes and take the upper 64 bytes as the shift result. However, the AVX512 instruction set does not have a direct instruction to perform this operation. Therefore, this operation is implemented through a combination of AVX512 instructions. To accomplish cross-domain shift, two AVX512 instructions are used: VALIGNQ and VPSHLDQ. In other domains, whether operating on an Intel® processor, an AMD® processor, an ARM®-based processor, or a RISC-V processor, and in different SIMD or vector processing models including, but not limited to, AVX2 or NEON SIMD extensions, other instructions may be used to simulate a cross-domain shift.

The VALIGNQ instruction takes three parameters, a, b, and imm. Both a and b are 64-byte-long registers, and imm is an integer value. VALIGNQ concatenates a and b into a 128-byte-long intermediate result, shifts the result right imm 8-byte positions, and stores the lower 64 bytes in the destination register.

The VPSHLDQ instruction takes three parameters, a, b, and imm. Both a and b are 64-byte registers, and imm is of integer value. VPSHLDQ divides a and b into 8 individual 64-bit integers, concatenates each pair of 64-bit integers from a and b to form an intermediate 128-bit result, left-shifts this result by imm bits, and stores the upper 64 bits in the destination register.

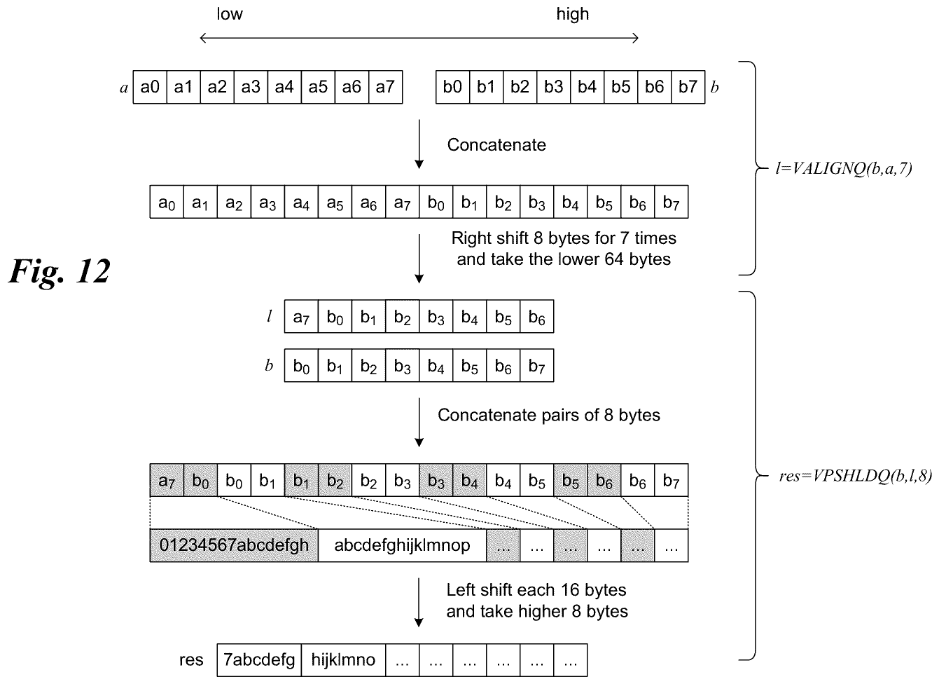

FIG. 12 graphically depicts an example of the cross-domain shift algorithm. Suppose that a=[a₀, a₁, a₂, a₃, a₄, a₅, a₆, a₇], a; (i∈[0, 8)) is 8-byte sequence and a₇=“01234567”, b=[b₀, b₁, b₂, b₃, b₄, b₅, b₆, b₇], bᵢ (i∈[0, 8)) is 8-byte sequence and b₀=“abcdefgh”, b₁=“ijklmnop”. To concatenate a with b, shift left 1 byte and take the higher 64 bytes, to get the result of “7abcdefghijklmnop . . . .”, we can utilize the VALIGNQ and VPSHLDQ instructions, as shown in FIG. 12. First, concatenate registers a and b using the VALIGNQ instruction. Take the highest 8 bytes from a and the lowest 56 bytes from b to obtain l. Then, leverage the VPSHLDQ instruction to concatenate each pair of 8 bytes from l and b, shift each 16 bytes and take the higher 8 bytes. Finally, the result register res is the concatenation of a and b left-shifted by 1 byte. Accordingly, we know that VPSHLDQ(b, VALIGNQ(b, a, 7), 8i) is to concatenate 64-byte a and b to get tmp, shifting tmp left i bytes and get the higher 64 bytes.

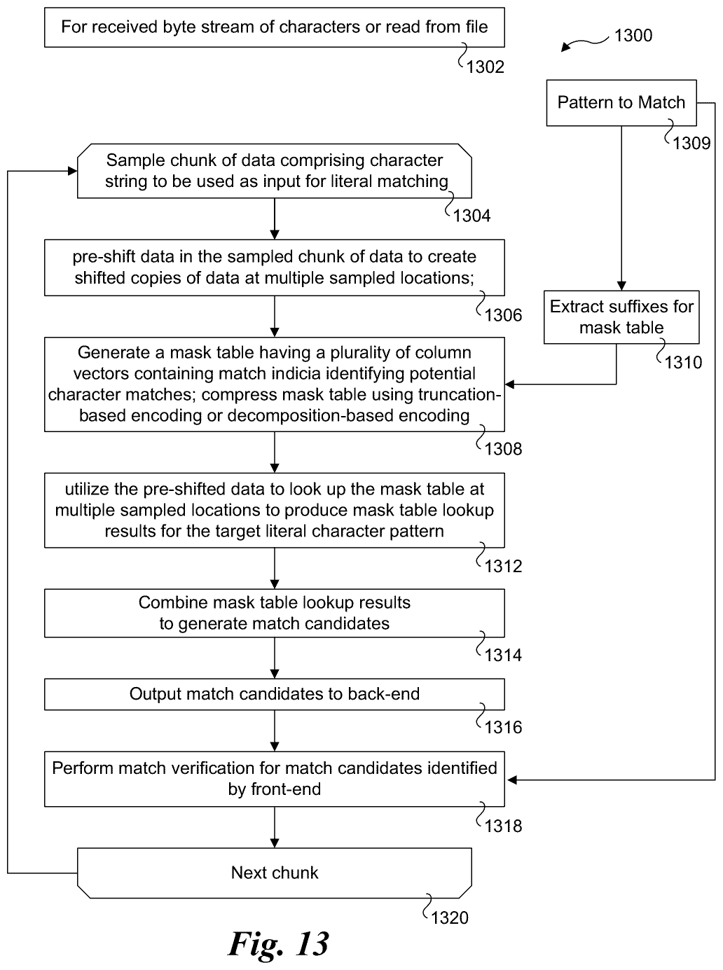

FIG. 13 shows a flowchart 1300 illustrating workflow operations implemented by NeoHarry, according to one embodiment. As shown in a block 1302, the operations are performed for a received byte stream or may be applied to stored file or document. As depicted by a start loop block 1304 and an end loop block 1320, the operations of blocks 1304, 1306, 1308, 1310, 1312, 1314, 1316, and 1318 are performed for each of multiple chunks of data sampled from the byte stream or file.

The chunk of data comprises a character string having a size n, such as 64 bytes. In a block 1306, data in the sampled chunk of data are pre-shifted to create shifted copies of data at multiple sampled locations. In a block 1308 a mask table is generated having a plurality of column vectors containing match indicia identifying potential character matches. The match indicia comprise suffixes that are extracted for the mask table from a pattern to match 1309 in block 1310. The mask table is then compressed using truncation-based encoding or decomposition-based encoding, as discussed above.

In a block 1310 the pre-shifted data are used to perform lookups in the mask table at multiple sampled location to produce mask table lookup results for the target literal character pattern corresponding to pattern to match 1309. The mask table lookup results are then combined (e.g., logically OR'ed) to generate match candidates. For example, in one embodiment, VPOR 512-bit SIMD instructions are used, while under an alternative embodiment, VPTERNLOG 512-bit SIMD instructions are used.

This completes the “front-end” operations. At this point, in a block 1316, the match candidates are output to a “back-end,” which, in a block 1318, performs exact match verification for match candidates identified by the front-end. The flow then proceeds to end loop block 1320 and loops back to start loop block 1304 to begin processing a next chunk of data.

FIG. 14 illustrates a simplified example diagram of a workflow using the NeoHarry algorithm with further details of the back-end exact matching. As above, the workflow process is applied to an input character stream or may be applied to stored files and documents, as depicted by an input 1400. In a block 1402, the NeoHarry algorithm front-end operations are performed (e.g., operations in blocks 1304, 1306, 1308, 1310, 1314, and 1316 of flowchart 1300). The result of the front-end operations is a set of match candidates 1404, which are provided as input to the back end 1406, which performs exact string pattern matching. In this example, back-end 1406 applies hashing 1408 to the match candidates, and then uses literal pattern 1410 to perform exact matching.

### Data-Level Parallelism

The novel NeoHarry algorithm improves both data processing efficiency and instruction parallelism to speed up the overall literal matching and even regex matching. As discussed above, NeoHarry breaks down the matching process into shift-or matching and exact matching. During shift-or matching, it groups literals into p buckets and matching only their 8-byte-long suffixes. Under the example architecture 400 in FIG. 4, p=8. After grouping literals into p buckets and truncating their 8-byte-long suffixes, the mask length is fixed to mp and the number of instructions in an iteration is 38-2. Depending on the encoding method, NeoHarry needs 38-1 or 58-1 instructions to process L/p bytes.

By comparison, Harry needs δ LOAD, δ SHIFT and δ OR operations to process L/p-δ bytes in an iteration. Using the AVX512 SIMD instruction set, the δ LOAD operations need δ VPERMB instructions, the δ SHIFT operations also need δ VPERMB instructions and the δ OR operations need δ VPOR instructions. Therefore, Harry needs 3δ or 5δ SIMD instructions to process L/p—δ bytes.

### Instruction-Level Parallelism

The instructions used by Harry and NeoHarry are shown in Table 1 and 2 below:

TABLE 1
Harry's Instruction Details

| Symbol | Operation | SIMD instruction | Latency | Port |
|---|---|---|---|---|
| LD | Load Data | VMOVDQU32 | 4 | 2, 3 |
| LM | Load Mask | VPERMB | 3 | 5 |
| SL | Shift Left | VPERMB | 3 | 5 |
| SR | Shift Right | VPERMB | 3 | 5 |
| O | OR | VPOR | 1 | 0, 5 |

TABLE 2
NeoHarry's Instruction Details

| Symbol | Operation | SIMD instruction | Latency | Port |
|---|---|---|---|---|
| LD | Load Data | VMOVDQU32 | 4 | 2, 3 |
| LM | Load Mask | VPERMB | 3 | 5 |
| SL | Cross Domain Shift | VPSHLDQ | 1 | 0, 1 |
| SR | Cross Domain Shift | VALIGNQ | 3 | 5 |
| O | OR | VPOR | 1 | 0, 5 |

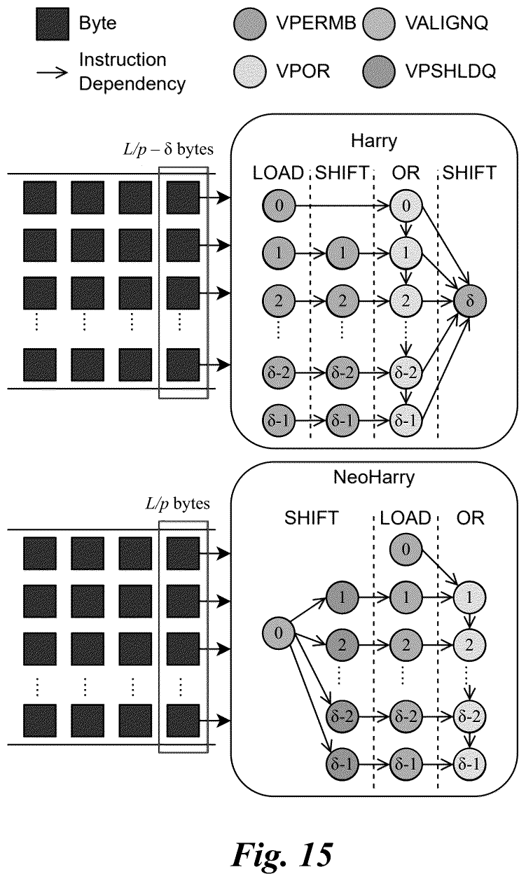

From above, Harry needs 3δ or 5δ instructions to process L/p—δ bytes and NeoHarry needs 3δ-1 or 5δ-1 instructions to process L/p bytes. NeoHarry takes a similar number of SIMD instructions compared to Harry and processes more data, so its data-level parallelism is higher than Harry. NeoHarry's instruction-level parallelism is also higher than Harry. Take the situation where Harry consumes 38 instructions and NeoHarry consumes 3δ-1 instructions as an example, their instruction dependency graph is shown in FIG. 15. A right arrow indicates the sequential order of execution between two instructions and is called a dependency. In theory, the fewer dependencies, the higher the parallelism degree.

As shown in FIG. 15, Harry has 48-2 dependencies and NeoHarry has 48-4 dependencies. While their dependency counts are relatively similar, NeoHarry has more types of instructions, which is beneficial for improving instruction-level parallelism, since the instructions used by NeoHarry have less port contention than the instructions used by Harry. In particular, Harry uses VPERMB instructions to perform Load Mask, Shift Left, and Shift Right operations, which results in overloading utilization of port 5. In comparison, since VPSHLDQ running on CPU port 0 or 1 replaces VPERMB running on port 5 in Shift Left operations, the load on port 5 is significantly reduced, resulting in better instruction parallelism in NeoHarry.

This is graphically illustrated in FIG. 16, which shows the instruction pipeline of Shift-Or matching for Harry and NeoHarry for CPU ports 0, 1, 2, and 5 for an Intel® Xeon® Platinum 8380 CPU. Harry consumes 19 CPU cycles to process 56 bytes and NeoHarry consumes 11 CPU cycles to process 64 bytes. NeoHarry can achieve a theoretical performance improvement of up to 1.97× compared to Harry.

### Exemplary Computing System

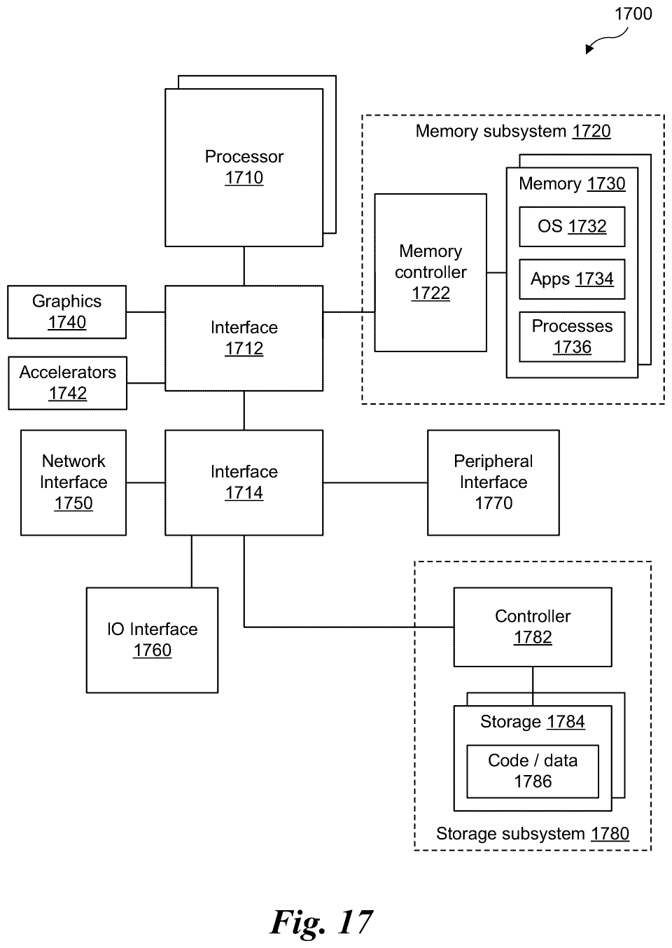

FIG. 17 depicts a computing system 1700 such as a server or similar computing system in which aspects of the embodiments disclosed above may be implemented. Computing system 1700 includes one or more processors 1710, which provides processing, operation management, and execution of instructions for computing system 1700. Processor 1710 can include any type of microprocessor, central processing unit (CPU), graphics processing unit (GPU), general-purpose GPU (GP-GPU), processing core, multi-core processor or other processing hardware to provide processing for computing system 1700, or a combination of processors. Processor 1710 controls the overall operation of computing system 1700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, computing system 1700 includes interface 1712 coupled to processor 1710, which can represent a higher speed interface or a high throughput interface for system components that needs higher bandwidth connections, such as memory subsystem 1720 or optional graphics interface components 1740, or optional accelerators 1742. Interface 1712 represents an interface circuit, which can be a standalone component or integrated onto a processor die. Where present, graphics interface 1740 interfaces to graphics components for providing a visual display to a user of computing system 1700. In one example, graphics interface 1740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1740 generates a display based on data stored in memory 1730 or based on operations executed by processor 1710 or both. In one example, graphics interface 1740 generates a display based on data stored in memory 1730 or based on operations executed by processor 1710 or both.

In some embodiments, accelerators 1742 can be a fixed function offload engine that can be accessed or used by a processor 1710. For example, an accelerator among accelerators 1742 can provide data compression capability, cryptography services such as public key encryption (PKE), cipher, hash/authentication capabilities, decryption, or other capabilities or services. In some embodiments, in addition or alternatively, an accelerator among accelerators 1742 provides field select controller capabilities as described herein. In some cases, accelerators 1742 can be integrated into a CPU socket (e.g., a connector to a motherboard or circuit board that includes a CPU and provides an electrical interface with the CPU). For example, accelerators 1742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1742 can provide multiple neural networks, CPUs, processor cores, general purpose graphics processing units, or graphics processing units can be made available for use by AI or ML models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1720 represents the main memory of computing system 1700 and provides storage for code to be executed by processor 1710, or data values to be used in executing a routine. Memory subsystem 1720 can include one or more memory devices 1730 such as read-only memory (ROM), flash memory, one or more varieties of random access memory (RAM) such as DRAM, or other memory devices, or a combination of such devices. Memory 1730 stores and hosts, among other things, operating system (OS) 1732 to provide a software platform for execution of instructions in computing system 1700. Additionally, applications 1734 can execute on the software platform of OS 1732 from memory 1730. Applications 1734 represent programs that have their own operational logic to perform execution of one or more functions. Processes 1736 represent agents or routines that provide auxiliary functions to OS 1732 or one or more applications 1734 or a combination. OS 1732, applications 1734, and processes 1736 provide software logic to provide functions for computing system 1700. In one example, memory subsystem 1720 includes memory controller 1722, which is a memory controller to generate and issue commands to memory 1730. It will be understood that memory controller 1722 could be a physical part of processor 1710 or a physical part of interface 1712. For example, memory controller 1722 can be an integrated memory controller, integrated onto a circuit with processor 1710.

While not specifically illustrated, it will be understood that computing system 1700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, computing system 1700 includes interface 1714, which can be coupled to interface 1712. In one example, interface 1714 represents an interface circuit, which can include standalone components and integrated circuitry. In one example, multiple user interface components or peripheral components, or both, couple to interface 1714. Network interface 1750 provides computing system 1700 the ability to communicate with remote devices (e.g., servers or other computing devices) over one or more networks. Network interface 1750 can include an Ethernet adapter, wireless interconnection components, cellular network interconnection components, USB (universal serial bus), or other wired or wireless standards-based or proprietary interfaces. Network interface 1750 can transmit data to a device that is in the same data center or rack or a remote device, which can include sending data stored in memory. Network interface 1750 can receive data from a remote device, which can include storing received data into memory. Various embodiments can be used in connection with network interface 1750, processor 1710, and memory subsystem 1720.

In one example, computing system 1700 includes one or more IO interface(s) 1760. IO interface 1760 can include one or more interface components through which a user interacts with computing system 1700 (e.g., audio, alphanumeric, tactile/touch, or other interfacing). Peripheral interface 1770 can include any hardware interface not specifically mentioned above. Peripherals refer generally to devices that connect dependently to computing system 1700. A dependent connection is one where computing system 1700 provides the software platform or hardware platform or both on which operation executes, and with which a user interacts.

In one example, computing system 1700 includes storage subsystem 1780 to store data in a nonvolatile manner. In one example, in certain system implementations, at least certain components of storage 1780 can overlap with components of memory subsystem 1720. Storage subsystem 1780 includes storage device(s) 1784, which can be or include any conventional medium for storing large amounts of data in a nonvolatile manner, such as one or more magnetic, solid state, or optical based disks, or a combination. Storage 1784 holds code or instructions and data 1786 in a persistent state (e.g., the value is retained despite interruption of power to computing system 1700). Storage 1784 can be generically considered to be a “memory,” although memory 1730 is typically the executing or operating memory to provide instructions to processor 1710. Whereas storage 1784 is nonvolatile, memory 1730 can include volatile memory (e.g., the value or state of the data is indeterminate if power is interrupted to computing system 1700). In one example, storage subsystem 1780 includes controller 1782 to interface with storage 1784. In one example controller 1782 is a physical part of interface 1714 or processor 1710 or can include circuits or logic in both processor 1710 and interface 1714.

In an example, computing system 1700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (ROCE), Peripheral Component Interconnect express (PCIe), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

### Example Use Cases

The NeoHarry algorithm may be used in a wide variety of use cases where an objective is to identify character strings and/or patterns in any type of alphanumeric content. The following list of use cases is exemplary and non-limiting. Search Engines and Content Search of large Corpus and Databases, Spam Filters, Intrusion Detection System, Plagiarism Detection, Bioinformatics and DNA Sequencing, Digital Forensics, Information Retrieval Systems etc. Various Packet Processing operating on Packet Payload content, including Deep Packet Inspection, Packet Filtering, Packet Switching. Uses in Virtualized Environments such as Application Routing, VM or Container Selection, and Microservices Selection. Pattern Searching of Encrypted Content including Encrypted Memory and Network Data Encryption uses.

The logic or workflow shown in the Figures herein may be representative of example methodologies for performing novel aspects described in this disclosure. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of an implementation. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Italicized letters, such as i′, j′, l′, ‘m’, ‘n’, ‘p’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments of this disclosure may be used as or to support a software program, software modules, firmware, and/or distributed software executed upon some form of processor, processing core, or embedded logic, or a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (e.g., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments, including what is described in the Abstract, is not intended to be exhaustive or to limit the embodiments to the precise forms disclosed. While specific embodiments of, and examples for, the disclosure are described herein for illustrative purposes, various equivalent modifications are possible within the scope of the disclosure, as those skilled in the relevant art will recognize.

These modifications can be made to the embodiments in light of the above detailed description. The terms used in the following claims should not be construed to be limited to the specific embodiments disclosed in the specification and the drawings. Rather, the scope of the claimed subject matter is to be determined entirely by the following claims, which are to be construed in accordance with established doctrines of claim interpretation.

What is claimed is:

1. A method for performing multi-literal matching for a target literal character pattern, comprising:
sampling a chunk of data from a byte stream, the chunk of data comprising a character string comprising n bytes;
pre-shifting data in the sampled chunk of data to create shifted copies of data at multiple sampled locations;
generating a mask table having a plurality of column vectors containing match indicia identifying potential character matches;
utilizing the pre-shifted data to look up the mask table at multiple sampled locations to produce mask table lookup results for the target literal character pattern; and
combining the mask table lookup results to generate match candidates.

2. The method of claim 1, further comprising performing exact match verification to identify any generated match candidates that match the target literal character pattern.

3. The method of claim 1, wherein generating the mask table comprises:
loading elements from a plurality of 2048-bit column vectors; and
encoding character data in the elements to form 512-bit column vectors.

4. The method of claim 3, wherein the encoding comprises truncation-based compression encoding under which the low 6 bits of an ASCII character are kept.

5. The method of claim 3, wherein the encoding comprises decomposition-based encoding under which 12-bit characters are generated in which 6 high bits of a character comprise the 6 low bits of a first ASCII character and 6 low bits of the character comprise the 6 low bits of a next ASCII character.

6. The method of claim 1, further comprising implementing a cross-domain shift algorithm under which a character pattern spanning two domains is enabled to be identified.

7. The method of claim 1, wherein n comprises 64 bytes, and the method is performed by executing a plurality of 512-bit single input multiple data (SIMD) instructions on a processor, the plurality of 512-bit SIMD instructions including a sequence of SHIFT, LOAD, and OR SIMD instructions.

8. The method of claim 7, wherein the SHIFT SIMD instructions include a set of VALIGNQ instructions followed by a set of VPSHLDQ instructions.

9. A non-transitory tangible machine-readable medium having instructions stored thereon comprising a software program or module for performing multi-literal matching for a target literal character pattern in a byte stream, wherein execution of the instructions on a processor of a computing system enables the computing system to:
sample a chunk of data from a byte stream, the chunk of data comprising a character string comprising n bytes;
pre-shift data in the sampled chunk of data to create shifted copies of data at multiple sampled locations;
generate a mask table having a plurality of column vectors containing match indicia identifying potential character matches;
utilize the pre-shifted data to look up the mask table at multiple sampled locations to produce mask table lookup results for the target literal character pattern;
combine the mask table lookup results to generate match candidates; and
perform exact match verification to identify any generated match candidates that match the target literal character pattern.

10. The non-transitory tangible machine-readable medium of claim 9, wherein generating the mask table comprises:
loading elements from a plurality of 2048-bit column vectors; and
encoding character data in the elements to form 512-bit column vectors.

11. The non-transitory tangible machine-readable medium of claim 10, wherein the encoding comprises truncation-based compression encoding under which the low 6 bits of an ASCII character are kept.

12. The non-transitory tangible machine-readable medium of claim 10, wherein the encoding comprises decomposition-based encoding under which 12-bit characters are generated in which 6 high bits of a character comprise the 6 low bits of a first ASCII character and 6 low bits of the character comprise the 6 low bits of a next ASCII character.

13. The non-transitory tangible machine-readable medium of claim 9, wherein execution of the instructions further enables the computing system to implement a cross-domain shift algorithm under which a character pattern spanning two domains is enabled to be identified.

14. The non-transitory tangible machine-readable medium of claim 9, wherein n comprises 64 bytes, and wherein the instructions include a plurality of 512-bit single input multiple data (SIMD) instructions including a sequence of SHIFT, LOAD, and OR SIMD instructions.

15. The non-transitory tangible machine-readable medium of claim 14, wherein the SHIFT SIMD instructions include a set of VALIGNQ instructions followed by a set of VPSHLDQ instructions.

16. A computing system, comprising:
a processor, coupled to memory, having a plurality of cores on which instructions are executed; and
instructions comprising a software program or module for performing multi-literal matching for a target literal character pattern in a byte stream, wherein execution of the instructions on a processor of a computing system enables the computing system to:
sample a chunk of data from a byte stream, the chunk of data comprising a character string comprising n bytes;
pre-shift data in the sampled chunk of data to create shifted copies of data at multiple sampled locations;
generate a mask table having a plurality of column vectors containing match indicia identifying potential character matches;
utilize the pre-shifted data to look up the mask table at multiple sampled locations to produce mask table lookup results for the target literal character pattern;
combine the mask table lookup results to generate match candidates; and
perform exact match verification to identify any generated match candidates that match the target literal character pattern.

17. The computer system of claim 16, wherein generating the mask table comprises:
loading elements from a plurality of 2048-bit column vectors; and
encoding character data in the elements to form 512-bit column vectors.

18. The computer system of claim 16, wherein execution of the instructions further enables the computing system to implement a cross-domain shift algorithm under which a character pattern spanning two domains is enabled to be identified.

19. The computer system of claim 16, wherein n comprises 64 bytes, and wherein the instructions include a plurality of 512-bit single input multiple data (SIMD) instructions including a sequence of SHIFT, LOAD, and OR SIMD instructions.

20. The computer system of claim 19, wherein the SHIFT SIMD instructions include a set of VALIGNQ instructions followed by a set of VPSHLDQ instructions.
